(19) United States
(12) Patent Application Publication
(10) Pub. No.: US 2009/0177509 A1
(43) Pub. Date: Jul. 9, 2009

(54) Business Service Management Dashboard

(76) Inventors: Joshua David, Round Rock, TX (US); Frunklin Tang, Austin, TX (US); Thomas Painter, Austin, TX (US)

Correspondence Address: HAMILTON & TERRILE, LLP, P.O. BOX 203518, AUSTIN, TX, 78720, US

(21) Appl. No.: 11/971,668

(22) Filed: Jan. 9, 2008

(51) Int. Cl. G06F 17/50; G06Q 10/00

(52) U.S. Cl. 705/7; 705/1

(57) ABSTRACT

A system for presenting a visual dashboard which presents real time information regarding health of business processes through the health of the underlying IT systems. Visual representation of the relationships of the underlying application architecture are also presented via the system. In certain embodiments, the system develops a visual hierarchy which represents the relationship of business processes and the underlying IT infrastructure, thus enabling presentation of information both about the health of the components, as well as the relationship between the components.

### BACKGROUND OF THE INVENTION

1. Field of the invention

The present invention relates to information handling systems and more particularly to providing an information handling system with a business service management dashboard.

### DESCRIPTION OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to present information using dashboard type functionality via information handling systems.

### SUMMARY OF THE INVENTION

In accordance with the present invention, a system for presenting a visual dashboard which presents real time information regarding health of business processes through the health of the underlying IT systems is set forth. Visual representation of the relationships of die underlying application architecture are also presented via the system. In certain embodiments, the system develops a visual hierarchy which represents the relationship of business processes and the underlying IT infrastructure, thus enabling presentation of information both about the health of the components, as well as the relationship between the components.

More specifically, in one embodiment, the invention relates to a method for providing information regarding the health of business processes which includes associating a plurality of business processes with a plurality of information technology systems, monitoring the health of the plurality of information technology systems, and providing information regarding the health of the plurality of business processes based upon the health of the plurality of information technology systems.

In another embodiment, the invention relates to an apparatus for providing information regarding the health of business processes which includes means for associating a plurality of business processes with a plurality of information technology systems, means for monitoring the health of the plurality of information technology systems, and means for providing information regarding the health of the plurality of business processes based upon the health of the plurality of information technology systems.

In another embodiment, the invention relates to an information handling system which includes a processor and memory coupled to the processor. The memory stores a system for providing information regarding the health of business processes. Instructions executable by the processor are included on the system for associating a plurality of business processes with a plurality of information technology systems, monitoring health of the plurality of information technology systems, and providing information regarding the health of the plurality of business processes based upon the health of the plurality of information technology systems.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system.

FIG. 2 shows a flow chart of the operation of a system for presenting a visual dashboard.

FIG. 3 shows an example screen presentation of the system for presenting a visual dashboard.

FIG. 4 shows an example screen presentation of the system for presenting a visual dashboard.

FIG. 5 shows an example screen presentation of the system for presenting a visual dashboard.

FIG. 6 shows an example screen presentation of the system for presenting a visual dashboard.

FIG. 7 shows an example screen presentation of the system for presenting a visual dashboard.

FIG. 8 shows an example screen presentation of the system for presenting a visual dashboard.

### DETAILED DESCRIPTION

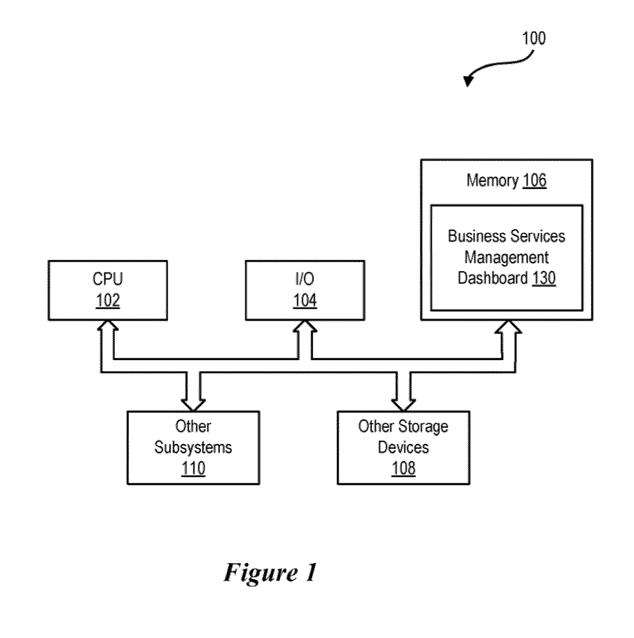

Referring briefly to FIG. 1, a system block diagram of an information handling system 100 is shown. The information handling system 100 includes a processor 102, input/output (I/O) devices 104, such as a display, a keyboard, a mouse, and associated controllers, memory 106, including volatile memory such as random access memory (RAM) and non-volatile memory such as read only memory (ROM) and hard disk drives, and other storage devices 108, such as a floppy disk and drive or CD-ROM disk and drive, and various other subsystems 110, all interconnected via one or more buses 112. The memory 106 includes a basic input output system 128 as well as a business service management dashboard module 130.

The business service management dashboard module 130 enables presentation of real time information regarding health of business processes through the health of the underlying IT systems. Visual representation of the relationships of the underlying application architecture is also presented via the business service management dashboard module 130. In certain embodiments, the business service management dashboard module 130 develops a visual hierarchy which represents the relationship of business processes and the underlying IT infrastructure, thus enabling presentation of information both about the health of the components, as well as the relationship between the components.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

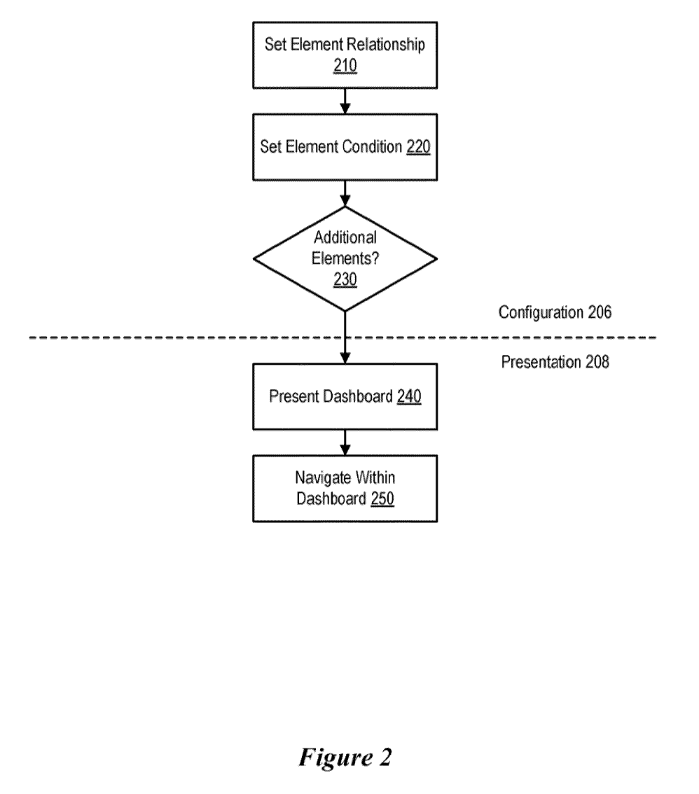

Referring to FIG. 2, a flow chart of the operation of a system for presenting a visual dashboard is shown. Operation of the system for presenting a visual dashboard 200 includes a configuration portion 206 and a presentation portion 208. Each of the configuration portion 208 and the presentation portion 208 may be executed separately and independently. Thus, when a particular IT system has been configured via the configuration portion 208, the system for presenting a visual dashboard need not re-execute the configuration portion 206 prior to executing the presentation portion 208. Additionally, while the presentation portion 208 is being executed, it is possible to return to the configuration portion 206 to modify or edit how certain portions of the visual dashboard operate.

More specifically, the configuration portion 206 of the system for presetting a visual dashboard 200 begins operation by setting an element relationship at step 210. An element relationship may be a parent/child relationship (where one element is a sub element of another element) or may be a sibling type relationship (where elements are located on the same level within the business process). Additionally, certain elements may have no relationship with other elements within the same business process. Additionally, certain business processes may have some or no relationship with other business processes.

After the element relationship is established, then the element condition for the element is established at step 220. The element condition establishes when to display a normal operating condition (e.g., a green color), warning condition (e.g., a yellow color) or a failure condition (e.g., a red color) based upon certain characteristics of the rule to which the element corresponds. The element condition can also be used to establish a weighting for the condition as well as a priority for the condition. Additionally, the element condition can also establish an interrelationship and weighting and priority for other elements that are related to the element.

After the element condition is established, then the system determines whether there are any additional elements at step 230. If yes, then control returns to step 210 to establish an element relationship another element. If no, then the system 200 may proceed to the presentation portion 208.

During the presentation portion 208, the system presents a dashboard at step 240. The dashboard can include one or more business process presentation portions. The system enables navigation within the dashboard presentation at step 250.

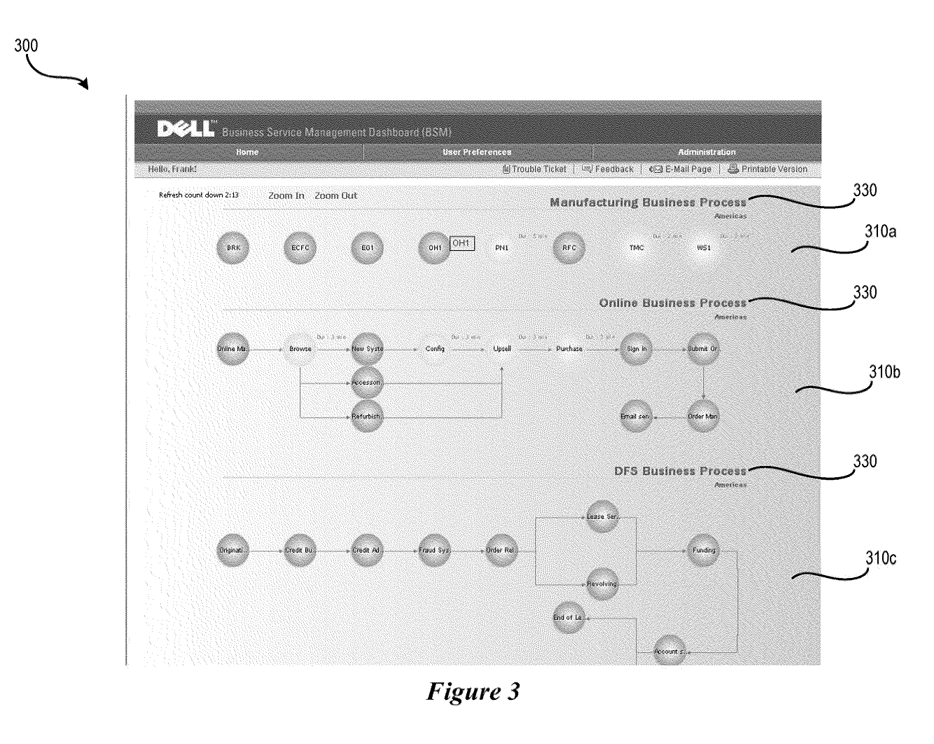

FIG. 3 shows an example screen presentation 300 of the system for presenting a visual dashboard. More specifically, the screen presentation includes a plurality of business process presentation portions 310a, 310b, 310c. Each of the business process presentation portions includes a plurality of business process elements 320. Each of the business process elements 320 represent health of a business process based upon the health of the underlying IT systems which support the business process. In certain embodiments, the health is represented via a color. So for example, an element which is presented in green represents a business process which is healthy (i.e. in which the underlying IT systems which support the business process are operating properly). An element 320 which is presented in yellow might represent a business process which may require attention (i.e., in which at least one of the underlying IT systems which support the business process might require attention). An element 320 which is presented in red might represent a business process which may require urgent attention (i.e., in which at least one of the underlying IT systems which support the business process might require urgent attention).

In certain embodiments, the elements are presented to show the interrelationship between the business processes. (See e.g., business presentation portion 310b.) Additionally, each of the business presentation portions 310 may include a corresponding title portion 330 to identify the corresponding business process.

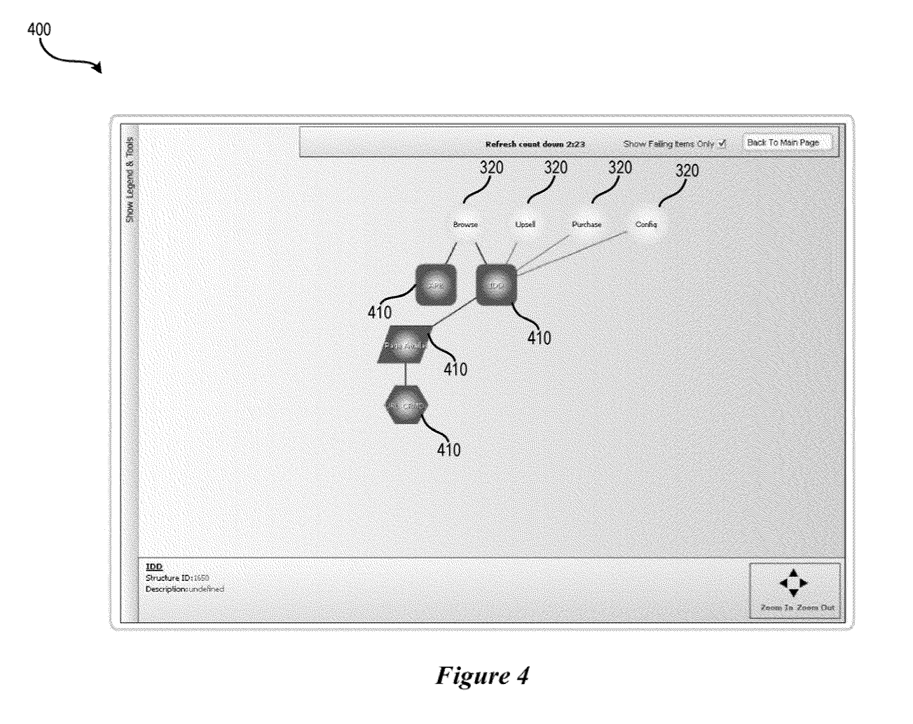

FIG. 4 shows an example screen presentation 400 of a function of the system for presenting a visual dashboard. More specifically, the system for presenting a visual dashboard can be configured to only present business process elements for which attention may be required. For example, the screen presentation 400 provides a more detailed view of the “Online Business Process” business process presentation portion 310b in which only those elements for which attention may be desired are presented. This screen presentation is further configured to present elements 410 representing the underlying IT systems which contribute to the indication that attention may be desired.

Additionally, certain sub elements 410 may contribute to more than one upper level element. E.g., the “IDD” element 410 contributes to each of the “Browse”, “Upself”, “Purchase” and “Config” elements 320, whereas the “APB” element 410 contributes only to the “Browse” element 320. Additionally, in certain embodiments, the shape of the elements and subelements conveys information to a user. For example, in certain embodiments, a square represents an application, a parallelogram represents a logical grouping such as infrastructure components and a hexagon represents a monitoring metric.

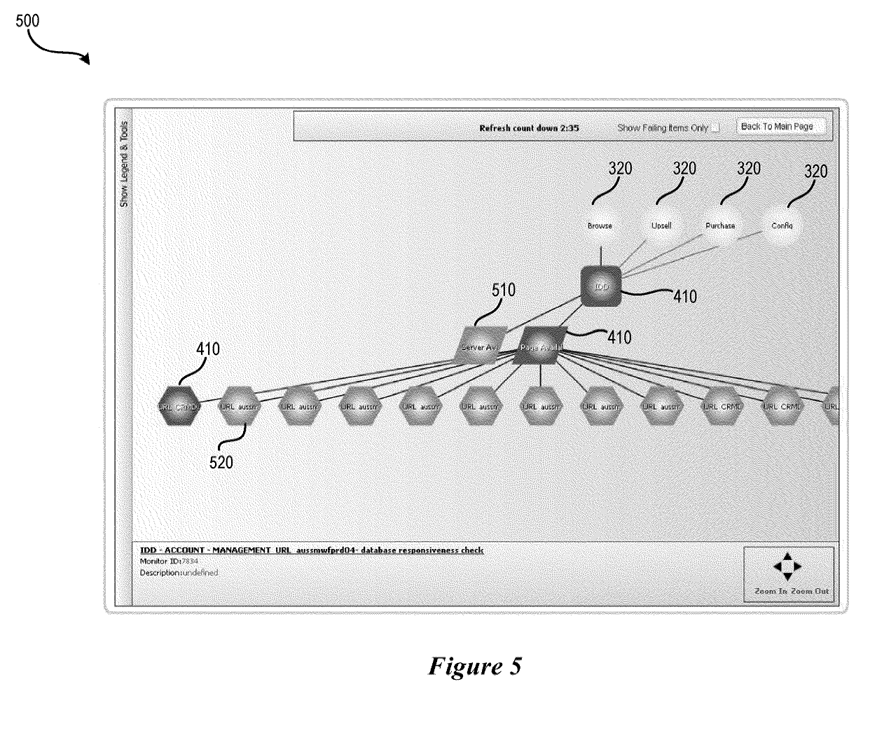

Referring to FIG. 5, another example screen presentation 500 of a function of the system for presenting a visual dashboard is shown. More specifically, the system for presenting a visual dashboard can be configured to present business process elements for which attention may be required along with elements that are functioning properly. For example, the screen presentation 500 provides a more detailed view of the “Online Business Process” business process presentation portion 310b in which elements for which attention may he desired are presented along with elements that are functioning properly.

This screen presentation 500 is further configured to present elements 410 representing the underlying IT systems which contribute to the indication that attention may be desired as well as elements 510, 520 representing underlying IT systems that are functioning properly. There may be a plurality of levels of underlying IT systems. So for example, the “URS aussit” element 520 is a sub element to the “Server Available” element 510. This screen presentation also provides an indication of the interrelationship of the various IT systems via the representation of the interrelationship of the corresponding elements.

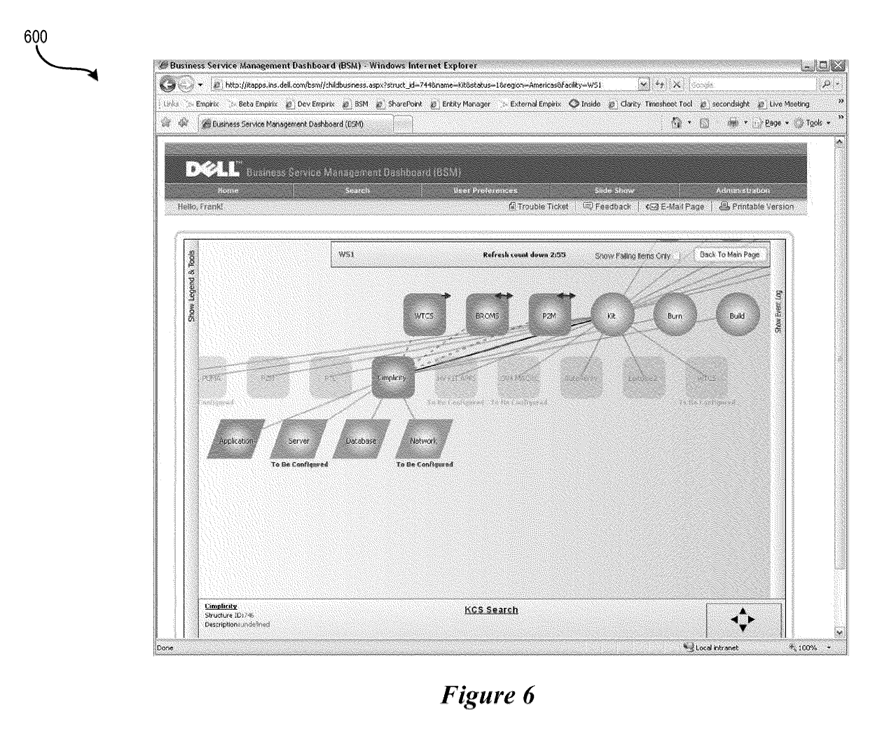

Referring to FIG. 6, another example screen presentation 600 of the system for presenting a visual dashboard is shown. More specifically, the system for presenting a visual dashboard can be configured to accent those elements for which action may be desired. Additionally, elements for which no action may be desired may be presented in an unaccented manner (e.g., via a ghosted presentation).

Additionally, in certain embodiments the system for presenting a visual dashboard can provide information regarding direct relationships between elements and subelements (e.g., via solid connecting lines) as well as indirect relationships between elements and subelements (e.g., via dashed connecting lines). Additionally, in certain embodiments additional indicia associated with an element can convey further information about the element and subelement relationships. More specifically, in certain embodiment, a left pointing arrow can indicate a down stream dependency, a right pointing arrow can indicate an up stream dependency (e.g., the “WTCS” element is an up stream dependence to the “Cimplicity” element) and a bidirectional arrow can indicate a bidirectional dependency (e.g., the “BROMS” element has a bi directional dependency to the “Cimplicity” element).

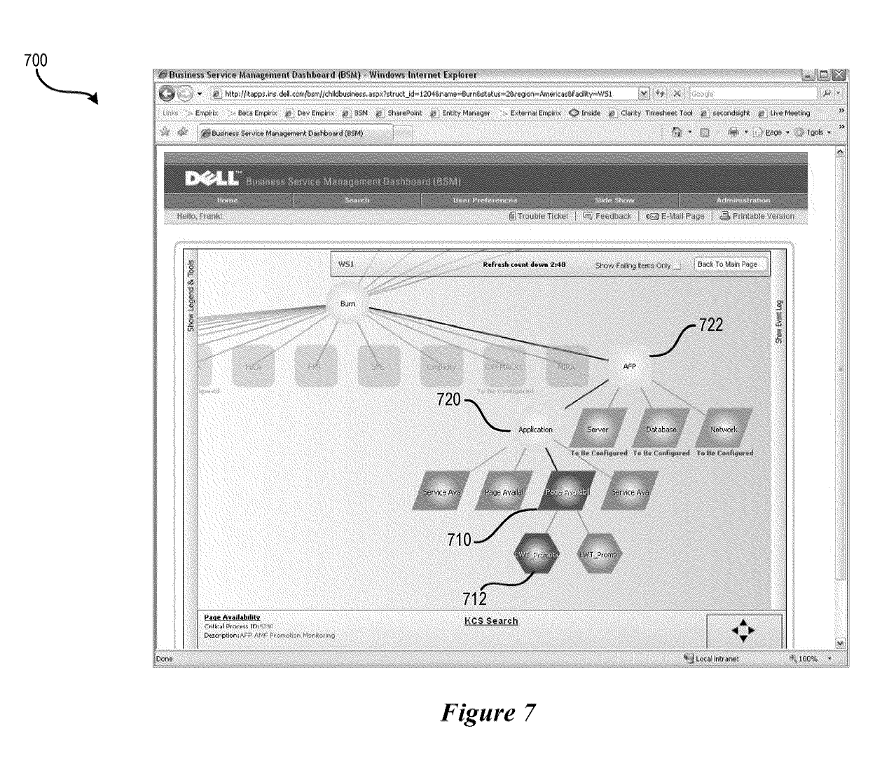

FIG. 7 shows another example screen presentation 700 of the system for presenting a visual dashboard. The system for presenting a visual dashboard can be used to provide additional detail on a particular element (i.e., to zoom to particular elements) as well as subelements that descend from the element. More specifically, the system for presenting a visual dashboard can be configured to accent a single element as well as subelements which descend from that element. Additionally, with this screen presentation, elements for which no action may be desired may be presented in an unaccented manner (e.g., via a ghosted presentation).

By providing a more detailed view of certain elements, it is possible to indicate whether certain subelements are in a failure mode of operation even if the element from which the subelements descend are not indicated as failing. For example, the “Page Available” subelement 710 and the “LWT Promotion” subelement 712 indicate a failure condition while the “Application” subelement 720 and the “AFP” subelement 722 might indicate a warning condition (as compared to the failure condition of the “Page Available” subelement 710 and the “LWT Promotion” subelement 712.

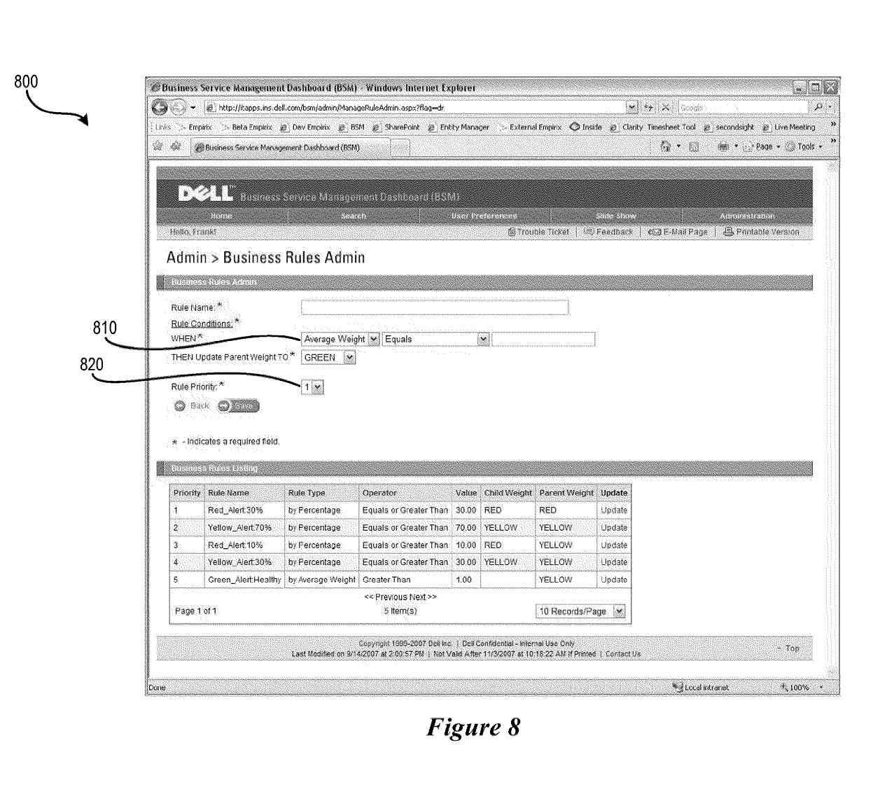

Referring to FIG. 8, an example screen presentation of control portion 800 of the system for presenting a visual dashboard is shown. More specifically, with the system for presenting a visual dashboard, elements may be edited to determine when to indicate that an element is operating in a failure condition or when an element is operating in a warning condition. This editing may include providing certain elements with a certain amount of weighting as well as a certain priority. Thus, a certain element can cause an upstream element to indicate a warning or failure condition when certain criteria are met, while another element having the same values might not cause the upstream element to indicate a warning or failure condition.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for providing information regarding health of business processes comprising:
associating a plurality of business processes with a plurality of information technology systems;
monitoring health of the plurality of information technology systems;
providing information regarding the health of the plurality of business processes based upon the health of the plurality of information technology systems.

2. The method of claim 1 wherein the providing information regarding the health of the plurality of business processes further comprises:
associating each of the plurality of information technology systems with respective information technology system elements; and,
presenting the information technology system elements such that the presenting provides information regarding the health of the plurality of business processes.

3. The method of claim 2 wherein the presenting further comprises:
presenting the information technology system elements in colors to provides information regarding the health of the plurality of business processes.

4. The method of claim 2 wherein the presenting the information technology system element in colors further comprises:
presenting the information technology system elements with at least one of a first color representing a normal operating condition, a second color representing a warning operating condition and a third color representing a failure operating condition.

5. The method of claim 2 wherein:
at least some of plurality of business processes comprise sub processes; and
further comprising:
associating each of the sub processes of information technology systems with respective information technology system sub elements; and,
the presenting the information technology system elements provides information regarding the health of the plurality of business processes and the health of the sub processes.

6. The method of claim 5 further comprising;
enabling adjusting of how the respective information technology system sub elements affect the health of the respective information technology system elements.

7. An apparatus for providing information regarding health of business processes comprising:
means for associating a plurality of business processes with a plurality of information technology systems;
means for monitoring health of the plurality of information technology systems;
means for providing information regarding the health of the plurality of business processes based upon the health of the plurality of information technology systems.

8. The apparatus of claim 7 wherein the means for providing information regarding the health of the plurality of business processes further comprises:
means for associating each of the plurality of information technology systems with respective information technology system elements; and,
means for presenting the information technology system elements such that the presenting provides information regarding the health of the plurality of business processes.

9. The apparatus of claim 7 wherein the means for presenting further comprises:
means for presenting the information technology system elements in colors to provides information regarding the health of the plurality of business processes.

10. The apparatus of claim 7 wherein the means for presenting the information technology system element in colors further comprises:
means for presenting the information technology system elements with at least one of a first color representing a normal operating condition, a second color representing a warning operating condition and a third color representing a failure operating condition.

11. The apparatus of claim 7 wherein:
at least some of plurality of business processes comprise sub processes; and
further comprising:
means for associating each of the sub processes of information technology systems with respective information technology system sub elements; and,
the means for presenting the information technology system elements provides information regarding the health of the plurality of business processes and the health of the sub processes.

12. The apparatus of claim 11 further comprising:
means for enabling adjusting of how the respective information technology system sub elements affect the health of the respective information technology system elements.

13. An information handling system comprising:
a processor;
memory coupled to the processor, the memory storing a system for providing information regarding health of business processes, the system comprising instruction executable by the processor for:
associating a plurality of business processes with a plurality of information technology systems;
monitoring health of the plurality of information technology systems;
providing information regarding the health of the plurality of business processes based upon the health of the plurality of information technology systems.

14. The information handling system of claim 13 wherein the instructions for providing information regarding the health of the plurality of business processes further comprise instructions for:
associating each of the plurality of information technology systems with respective information technology system elements; and,
presenting the information technology system elements such that the presenting provides information regarding the health of the plurality of business processes.

15. The information handing system of claim 14 wherein the instructions for presenting further comprise instruction for:
presenting the information technology system elements in colors to provides information regarding the health of the plurality of business processes.

16. The information handling system of claim 14 wherein the instructions for presenting the information technology system element in colors further comprise instructions for:
presenting the information technology system elements with at least one of a first color representing a normal operating condition, a second color representing a warning operating condition and a third color representing a failure operating condition.

17. The information handling system of claim 14 wherein:
at least some of plurality of business processes comprise sub processes; and the system further comprises instructions for:
associating each of the sub processes of information technology systems with respective information technology system sub elements; and,
the presenting the information technology system elements provides information regarding the health of the plurality of business processes and the health of the sub processes.

18. The information handling system of claim 17 wherein the system further comprises instructions for:
enabling adjusting of how the respective information technology system sub elements affect the health of the respective information technology system elements.
